(19) United States
(12) Patent Application Publication
(10) Pub. No.: US 2023/0376969 A1
(43) Pub. Date: Nov. 23, 2023

(54) PROVIDING CUSTOMER SERVICE WITHIN A METAVERSE

(71) Applicant: Bank of America Corporation, Charlotte, NC (US)

(72) Inventors: Trish Gillis, Chicago, IL (US); Jennifer Sanctis, Charlotte, NC (US); Taylor Farris, Hoboken, NJ (US)

(21) Appl. No.: 17/750,592

(22) Filed: May 23, 2022

(51) Int. Cl. G06Q 30/00; G06T 13/40; G06F 3/01; G06F 21/31

(52) U.S. Cl. CPC G06Q 30/016; G06T 13/40; G06F 3/011; G06F 21/31

(57) ABSTRACT

Apparatus and methods are provided for supplying customer service within a metaverse. A program may receive a request to authenticate a customer service representative and authenticate the service representative. The program may create a customer service avatar within the metaverse and assign the service avatar to the service representative. The program may interface between the service representative and the service avatar. The service avatar may move proximate to a user's avatar when the user requests assistance. The service representative may provide assistance to the user through the service avatar.

### FIELD OF TECHNOLOGY

This application includes apparatus and methods for providing assistance and customer service to a user within a metaverse.

### BACKGROUND

A metaverse may refer to a shared virtual environment or world, accessed by users through virtual reality or augmented reality devices, or other devices. Users may be able to interact with the virtual environment as well as with other users within the metaverse. The virtual environment may include simulated environments, simulated stores, simulated/actual applications, as well as other locations. A metaverse may refer to a single metaverse (as an analogue to the real or an imagined world) or multiple metaverses that may or may not be analogues to the real world.

Users may be represented within the metaverse (to other users or to computers) by avatars. Avatars may appear as facsimiles of the user or as creative representations of the user. Avatars may be assigned to a user by a central authority. Avatars may be designed by a user. Users may also have usernames within the metaverse. Usernames may be the user's actual name or a unique identifier chosen by (or assigned to) the user.

Transactions and other financial activities may occur within the metaverse. Financial institutions may create a virtual location/storefront within the metaverse. Retail or other stores may sell real or virtual items within the metaverse, at a virtual location/storefront or otherwise. In addition, real currency, cryptocurrencies (distributed ledger tokens) and non-fungible tokens (“NFTs”) may be bought, sold, and traded within the metaverse.

A user or group of users may require assistance while within the metaverse. For example, a user may not be able to complete a transaction or interaction and may require assistance. It may be more conducive to customer retention and appreciated to provide assistance while the user is within the metaverse, as opposed to the user being required to leave the metaverse (or metaverse session) to obtain assistance.

Therefore, it would be desirable to provide apparatus and methods for providing assistance and customer service to a user or user's avatar within a metaverse.

### SUMMARY OF THE DISCLOSURE

It is an object of this disclosure to provide apparatus and methods for supplying customer service and assistance to a user within a metaverse, increasing customer retention and satisfaction among other benefits.

A customer service computer program product for assisting a user within a metaverse is provided. The computer program product may include executable instructions that may be executed by a processor on a computer system.

The executable instructions may be configured to receive from a service representative, a request to authenticate the service representative. The instructions may authenticate the service representative and, when authenticated, create a service avatar within the metaverse. The instructions may be configured to assign the service avatar to the service representative and interface between the service representative and the service avatar. The program may interface between the service representative and the service avatar by transmitting one or more interactions from the service representative to the service avatar. Interactions may include text, movement, speech, video, instructions, and any other appropriate interaction. The interactions may be intended to assist a user within the metaverse who has requested assistance.

The service avatar may be configured to receive the one or more interactions from the service representative, move proximate to a user avatar in the metaverse in response to a help request transmitted by the user, and recreate the one or more interactions within the metaverse. For example, a user may request assistance to complete a particular transaction. The service avatar may move (virtually, within the metaverse) near the user avatar and transmit assistance from the service representative to the service avatar, which may then display or communicate that assistance in the metaverse. Assistance may take any appropriate form, such as text, speech (audio), video, backend computer assistance, etc.

In an embodiment, the transmission of the one or more interactions may be encrypted.

In an embodiment, the service representative may be an artificial intelligence (“AI”) bot. In an embodiment, the AI bot may provide an initial level of assistance and may be replaced by a human when a more sophisticated level of assistance is provided. In an embodiment, this replacement may be seamless such that the user may not know that service avatar is transmitting interactions from an AI bot or a human. In an embodiment, the replacement may be visible such that the user is made aware of the replacement.

In an embodiment, a second service representative may replace the initial (or first) service representative. This process may be repeated. In an embodiment, this replacement may be seamless such that the user may not know that service avatar is transmitting interactions from the first service representative or the second representative. In an embodiment, the replacement may be visible such that the user is made aware of the replacement.

In an embodiment, the service avatar may be an avatar overlay instead of an entire avatar. In this embodiment, the service representative may already have an avatar within the metaverse, and the computer program may provide a service avatar displaying that the avatar is now providing customer service as a service avatar. This may be visualized in any appropriate manner, such as providing a label, a glow, an article of clothing (jacket, hat, etc.), an identification, a specific avatar design, or any other visual representation that the avatar is supplying customer service.

In an embodiment, the service avatar may be linked to a particular location within the metaverse. For example, a service avatar for a particular store location (or financial institution location, etc.) may be located near the store location within the metaverse. In an embodiment, the particular location may be an analogue of a geographical location. For example, a store located at a particular location in the United States may have an analogue location within the metaverse. This metaverse may be an attempt to recreate part or all of the physical Earth within the metaverse.

In an embodiment, the service avatar may automatically move near the user avatar within a pre-determined time of the help request. The pre-determined time may be variable. The variable time and other parameters (distance to the user, from what direction, etc.) may be determined through one or more artificial intelligence/machine learning (“AI/ML”) algorithms.

In an embodiment, the service avatar may move near the user avatar only when the user is authenticated. If the user is not authenticated, the service avatar may ignore the user help request, or respond saying that no help may be provided until the user is authenticated.

In an embodiment, the service avatar may move near the user avatar only when the user is authenticated to an appropriate level. Various levels of help and authentication may be provided, with the levels corresponding to each other. For example, the highest level of authentication may have access to the highest level of customer service, while a lower level of authentication may have access to more limited customer service avatars.

In an embodiment, the service representative may be a tier-n service representative, the service avatar may be a tier-n service avatar, and the user may be authenticated to tier-n. “n” may refer to different levels of service and authentication, such as tiers 1, 2, 3, . . . n, with n being the highest level of service and authentication. An authentication level of tier 3 may have access to service representatives of tiers 1, 2, and 3, but not tiers 4 or higher.

Higher tiers of authentication may refer to more robust and secure authentication. For example, a simple PIN may be tier 1, a password may be tier 2, a stronger password with more requirements may be tier 3, biometric security may be tier 4, a combination of password and biometrics may be tier 5, etc.

Higher tiers of customer service and service avatars may refer to more available tools for the representative to assist the user. For example, a tier 1 representative may only have access to the most basic tools to assist the user, a tier 2 representative may have access to more tools, a tier 3 representative may have access to even more tools, etc.

In an embodiment, the service representative may be a tier-n service representative, the service avatar may be a tier-n service avatar, and the user (requesting assistance) may be authenticated to tier-(n−1). In this embodiment, instead of the service avatar moving near the user's avatar, a message may be transmitted to the user declining movement of the tier-n service avatar. The message may include any appropriate statements, including directions to the correct level of service avatar or a request to the user to authenticate to the appropriate level.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure.

FIG. 2 shows illustrative apparatus in accordance with principles of the disclosure.

FIG. 3 shows an illustrative schematic in accordance with the principles of the disclosure.

FIG. 4 shows an illustrative schematic in accordance with the principles of the disclosure.

FIG. 5 shows an illustrative flowchart in accordance with the principles of the disclosure.

FIG. 6 shows an illustrative apparatus in accordance with the principles of the disclosure.

### DETAILED DESCRIPTION

A customer service computer program product for assisting a user within one or more metaverses is provided. The computer program product may include executable instructions that may be executed by a processor on a computer system.

The computer system may be any suitable computer system, such as a server, a mobile device, a smartphone, etc. The server may be centralized or distributed. The computer system may include various components, such as one or more processors, non-transitory memory, communication links, input/output modules, display screens, peripherals, an operating system, various applications, as well as other components.

The executable instructions may be configured to, inter alia, receive from a service representative, a request to authenticate the service representative. The service representative may be employed by one or more entities. The service representative may be a volunteer. The service representative may be an automated bot. The service representative may control one or more service avatars within the metaverse. Any suitable authentication methods may be used, such as one-time passwords, passwords, multi-factor authentication, PINs, biometric attributes, and any other suitable authentication method

The service representative may transmit the request from any suitable computer, such as a smartphone, a mobile device, a virtual reality/augmented reality headset, a desktop computer, a laptop computer, or other computer system. The service representative may transmit the request when the service representative desires to be authenticated within the metaverse, e.g., when the service representative plans on assisting other users within the metaverse. In an embodiment, the service representative may transmit the request as a pre-requisite to joining a session within the metaverse (i.e., as part of a login procedure).

The instructions may be configured to authenticate the service representative and, when authenticated, create a service avatar within the metaverse. Any appropriate authentication method or protocol may be used. As discussed in more detail infra, in an embodiment, the better (more secure) the authentication method used to authenticate the service representative, the more abilities the service representative will have to provide additional assistance to the user.

The service avatar may be a standard design that is similar to all other service avatars created by the program. This may allow a user to recognize a service avatar immediately as well as save computing resources. Alternatively, each service avatar created by the program may have a unique look. In an embodiment, the service avatar may be a digital facsimile of the service representative, which may look similar to the service representative.

In an embodiment, the program may utilize one or more artificial intelligence/machine learning (“AI/ML”) algorithms to create the service avatar. Various factors may be considered by the AI/ML algorithms, such as the seniority of the service representative, the type of entity the service representative is employed by/volunteering for, what look may be most accepted by the user (some users may more readily accept help from avatars that are similar to them, while other users may not care), available computing power, time of day (in reality and in the metaverse), physical location of the service representative, physical location of the user, what the user needs assistance with, past history of the user and the service representative, as well as other factors.

The instructions may be configured to assign the service avatar to the service representative and interface between the service representative and the service avatar. In various embodiments, one service representative may control multiple service avatars, or multiple service representatives may have access to a single service avatar.

The program may act as an interface between the service representative and the service avatar by transmitting one or more interactions from the service representative to the service avatar. For example, the service representative may type a response to the user. The program may receive that typed response and translate it into speech and have the service avatar visually and auditorily speak the response, instead of having it appear in text form.

In an embodiment, the service representative may interact directly with the service avatar, without the program in the middle.

Interactions may include text, movement, speech, video, instructions, and any other appropriate interaction. The interactions may be intended to assist a user within the metaverse who has requested assistance. The assistance request may be in speech, text, or any other appropriate format. For example, if a user requests help performing a particular transaction, the service representative may respond to that request by typing a response into the program at an appropriate location.

The program (or directly in an embodiment) may transmit the response to the service avatar and have the service avatar display the response, in any appropriate format, within the metaverse. An appropriate output format may be determined by the program through any appropriate method, including one or more AI/ML algorithms. For example, an appropriate output format may include the service avatar speaking the response at a volume loud enough for the user avatar to hear. Alternatively, a text box may appear near the service avatar including the response. The text box may be inappropriate if the service avatar is behind the user avatar (and thus not easily visible to the user), while speech may be better suited in this situation. An appropriate output format may include the service avatar completing a transaction for a user.

The service avatar may be configured to receive the one or more interactions from the service representative, then move proximate to a user avatar in the metaverse in response to a help request transmitted by the user and recreate the one or more interactions within the metaverse. Alternatively, the service avatar may recreate the one or more interactions after receipt from the service representative but before any help request is transmitted. For example, a service representative may transmit one or more interactions at set periods or other times. For illustrative purposes, an example may be the service representative instructing the service avatar to wave at a passing user avatar, as if to say, “I'm here to help if needed.”

In another example, a user may request assistance to complete a particular transaction. The service avatar may move near the user avatar, the program may transmit interactions as assistance from the service representative to the service avatar, which may then display or communicate that assistance in the metaverse. Assistance may take any appropriate form, such as text, speech (audio), video, backend computer assistance, etc.

In an embodiment, the transmission of the one or more interactions may be encrypted. Any appropriate encryption protocol may be utilized. Encryption may be important, especially if assistance is requested for financial or other transactions.

In an embodiment, the service representative may be an artificial intelligence (“AI”) bot. In an embodiment, the AI bot may provide an initial level of assistance and may be replaced by a human when a more sophisticated level of assistance is provided. In an embodiment, this replacement may be seamless such that the user may not know that service avatar is transmitting interactions from an AI bot or a human. In this embodiment, the presentation of the service avatar may not change.

In an embodiment, the replacement service representative may be visible such that the user is made aware of the replacement. For example, the service avatar may be visually changed by the program.

In an embodiment, a second service representative may replace the initial (or first) service representative. This process may be repeated. In this embodiment, the service avatar may remain the same, but control of the avatar may shift from the first service representative to the second service representative.

In an embodiment, this replacement may be seamless such that the user may not know that service avatar is transmitting interactions from the first service representative or the second representative. In an embodiment, the replacement may be visible such that the user is made aware of the replacement.

In an embodiment, the service avatar may be an avatar overlay instead of an entire avatar. In this embodiment, the service representative may already have an avatar within the metaverse, and the computer program may provide a service avatar displaying that the avatar is now providing customer service as a service avatar. This may be visualized in any appropriate manner, such as providing a label, a glow, an article of clothing (jacket, hat, etc.), an identification, or any other visual representation that the avatar is supplying customer service.

In an embodiment, the service avatar, or avatar overlay may be time limited. The service avatar may disappear from the metaverse when the service representative logs off. Alternatively, the service avatar may cease to exist when a deletion condition occurs, such as a log off, or the end of an interaction between the service representative and the user requesting assistance.

In an embodiment, the service avatar may be linked to a particular location within the metaverse. For example, a service avatar for a particular store location (or financial institution location, etc.) may be located near the store location within the metaverse. The service representative may be associated with the store or other location. In an embodiment, the service representative may be associated with two or more stores or locations and may be responsible for providing customer service at multiple locations.

In an embodiment, the particular location may be an analogue of a geographical location. For example, a store located at a particular location in the United States may have an analogue location within the metaverse. This metaverse may be an attempt to recreate part or all of the physical Earth within the metaverse, including customer service representatives to help customers or potential customers.

In an embodiment, the service avatar may automatically move near the user avatar within a pre-determined time of the help request. For example, the service representative may be required (by company policy, metaverse policy, hardware constraints, or otherwise) to position the service avatar near the user's avatar within one minute (or some other pre-determined time) of receiving the help request.

In an embodiment, the pre-determined time may be variable. The variable time and other parameters (distance to the user, from what direction, etc.) may be determined through one or more artificial intelligence/machine learning (“AI/ML”) algorithms. Various factors may be used, including, inter alia, the location of the service avatar, the location of the user avatar, past history of the user, the nature of the help request, time of day, availability of service representatives, as well as other factors.

In an embodiment, the service avatar may move near the user avatar only when the user is authenticated. Requiring the user be authenticated may provide security benefits and prevent malicious activity. If the user is not authenticated, the service avatar may ignore the user help request, or respond saying that no help may be provided until the user is authenticated. Other responses may be used, as appropriate.

In an embodiment, the service avatar may move near the user avatar only when the user is authenticated to an appropriate level of authentication. In an embodiment, the level of authentication of the user may be visible on the user's avatar. In another embodiment, the level of authentication of the user may be communicated to the program or the service representative along with the request for assistance.

Various levels of help and authentication may be provided, with the levels corresponding to each other. For example, the highest level of authentication may have access to the highest level of customer service, while a lower level of authentication may have access to more limited customer service avatars/service representatives.

In an embodiment, the service representative may be a tier-n service representative, the service avatar may be a tier-n service avatar, and the user may be authenticated to tier-n. “n” may refer to different levels of service and authentication, such as tiers 1, 2, 3, . . . n, with n being the highest level of service and authentication. For example, an authentication level of tier 3 may have access to service representatives of tiers 1, 2, and 3, but not tiers 4 or higher. The number of tiers may be preset by the program, the metaverse, the service representative, an entity providing assistance, or other users.

Various locations/stores within the metaverse may have various levels/tiers of service representatives available to provide assistance. For example, one store may have a tier 3 and a tier 5 representative available, while another store may only have a tier 4 representative available. Another location may not have any service representatives available.

Higher tiers of authentication may refer to more robust and secure authentication. For example, a simple PIN may be tier 1, a password may be tier 2, a stronger password with more requirements may be tier 3, biometric security may be tier 4, a combination of password and biometrics may be tier 5, etc. These tiers and what they represent may vary between entities and other service providers within the metaverse. For example, a financial institution providing banking services within the metaverse may require more robust authentication than a news provider.

Higher tiers of customer service and service avatars may refer to more available tools/services for the representative to assist the user. For example, a tier 1 representative may only have access to the most basic tools to assist the user, a tier 2 representative may have access to more tools, a tier 3 representative may have access to even more tools, etc. In a financial institution aspect, a higher tier service representative may be required to assist a user with more services, such as transferring money out of an account will require a higher tier than placing money into an account.

In an embodiment, the service representative may be a tier-n service representative, the service avatar may be a tier-n service avatar, and the user (requesting assistance) may be authenticated to tier-(n−1). In this embodiment, instead of, or in addition to, the service avatar moving near the user's avatar, a message may be transmitted to the user declining movement of or further assistance from the tier-n service avatar. The message may include any appropriate statements, including directions to the correct level of service avatar or a request to the user to authenticate to the appropriate level.

A method for assisting a user within a metaverse is provided. The method may include receiving, at a customer service computer program, a request to authenticate a customer service representative. The method may include authenticating, at the customer service computer program, the service representative. The method may include creating, by the customer service computer program, a customer service avatar within the metaverse.

The method may include assigning the customer service avatar to the customer service representative. The method may include interfacing between the customer service representative and the customer service avatar by transmitting one or more interactions from the service representative to the service avatar. The method may include receiving a help request from the user (or the user's avatar). The method may also include moving the customer service avatar near the user's avatar within the metaverse. The method may include recreating the one or more interactions from the customer service representative with the customer service avatar.

In an embodiment, the method may include the customer service computer program automatically moving the customer service avatar near the user within the metaverse within a pre-determined time of receiving the help request from the user.

In an embodiment, the customer service avatar may expire after a pre-determined length of time. In an embodiment, the pre-determined length of time may be variable.

In an embodiment, the customer service representative may be a tier-n service representative, the customer service avatar may be a tier-n service avatar, and the user may be authenticated to tier-n. When the user and customer service representative are at the same tier, the customer service representative may be able to assist the user with all tier-appropriate services.

In an embodiment, when the service representative may be a tier-n service representative, the service avatar may be a tier-n service avatar, but the user is authenticated to tier-(n−1), a message may be transmitted to the user declining assistance to the user. In this embodiment, the user may not be able to take advantage of the service representative as the user may not be authenticated to the appropriate level. For example, if a user is only authenticated to tier 1 (a PIN) but wants help with a service that requires tier 3 authentication (for example, a large bank transfer), the customer service representative, through the service avatar, may decline to assist the user, until the user is authenticated to tier 3.

An apparatus for assisting a user within a metaverse is provided. The apparatus may include a server and other components. The server may be centralized or distributed.

The server may include a communication link, a processor, and a non-transitory memory, among other components (such as a display and input/output modules). The non-transitory memory may be configured to store, inter alia, an operating system and a customer service program.

The customer service program may include executable instructions that when executed on the processor are configured to, inter alia: receive, from a service representative, a request to authenticate the service representative, authenticate the service representative, create a service avatar within the metaverse, assign the service avatar to the service representative, and interface between the service representative and the service avatar by transmitting one or more interactions from the service representative to the service avatar. The service avatar may be configured to receive the one or more interactions from the service representative, move proximate to a user avatar located within the metaverse in response to a help request transmitted by the user, and recreate the one or more interactions within the metaverse.

In an embodiment, the service avatar may be available to assist the user only when the user is authenticated to a particular standard.

In an embodiment, when the user is authenticated to a lower standard than the service avatar, the service avatar may be unable to assist the user.

In an embodiment, the program may create an avatar overlay instead of an avatar. This may occur when the service representative already has an avatar within the metaverse, and no new avatar is needed. The avatar overlay may appear within the metaverse. The avatar overlay may be superimposed upon the user's existing avatar. The avatar overlay may replace the service representative's existing avatar. The avatar overlay (or avatar) may automatically expire after a pre-determined length of time. The avatar overlay (or avatar) may automatically expire at a pre-determined time. The avatar overlay (or avatar) may automatically expire when an expiration condition is met. For example, an expiration condition may be the service representative exiting the metaverse (logging off), or the service representative completing providing assistance to the user within the metaverse.

Various protocols for wired or wireless communication may be used by the apparatus and service program. The communication link may provide Wi-Fi, Near Filed Communication (“NFC”), cellular (including 5g), Bluetooth or any other suitable mode of wired or wireless communication. Wi-Fi may include passive Wi-Fi having lower power consumption than typical Wi-Fi.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

A processor(s) may control the operation of the apparatus and its components, which may include RAM, ROM, an input/output module, and other memory. The microprocessor may also execute all software running on the apparatus. Other components commonly used for computers, such as EEPROM or Flash memory or any other suitable components, may also be part of the apparatus.

A communication link may enable communication with any computing device where the service representative may attempt to authenticate from as well as any server or servers. The communication link may include any necessary hardware (e.g., antennae) and software to control the link. Any appropriate communication link may be used. In an embodiment, the network used may be the Internet. In another embodiment, the network may be an internal intranet.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with any other illustrative apparatus and/or method embodiment.

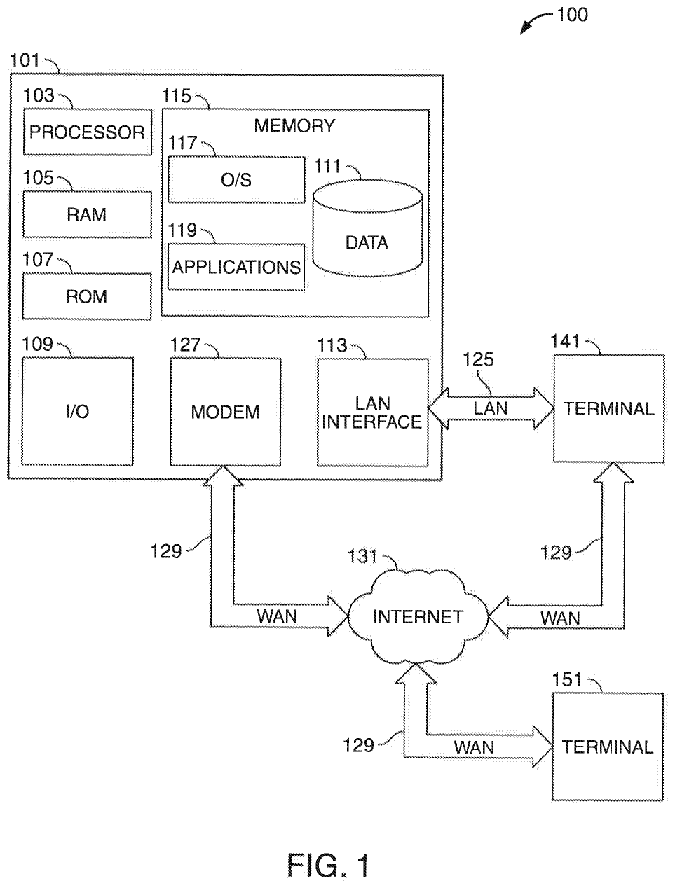

FIG. 1 is a block diagram that illustrates a computing device/apparatus 100 that may be used in accordance with the principles of the invention. The device 101 may have a processor 103 for controlling overall operation of the device and its associated components, including RAM 105, ROM 107, input/output (“I/O”) module 109, and memory 115.

I/O module 109 may include a microphone, keypad, touchscreen, microphone, camera/eye tracker, stylus, or other apparatus through which a user of device 101 may provide input and may also include one or more of a speaker for providing audio output and a video display device for providing textual, audiovisual and/or graphical output. Software may be stored within memory 115 and/or other storage (not shown) to provide instructions to processor 103 for enabling device 101 to perform various functions, such as providing real-time customized software to a user or target output channel. For example, memory 115 may store software used by device 101, such as an operating system 117, application programs 119, and an associated database.

Alternatively, some or all of computer executable instructions of device 101 may be embodied in hardware or firmware (not shown).

Device 101 may operate in a networked environment supporting connections to one or more remote computers or servers, such as terminals 141 and 151. Terminals 141 and 151 may be backend computers, servers, or other channels that include many or all of the elements described above relative to device 101. The network connections depicted in FIG. 1 include a local area network (LAN) 125 and a wide area network (WAN) 129 but may also include other networks.

When used in a LAN networking environment, device 101 is connected to LAN 125 through a network interface or adapter 113.

When used in a WAN networking environment, device 101 may include a modem 127 or other means for establishing communications over WAN 129, such as Internet 131. Bluetooth, cellular, NFC or other communication protocols may also be used.

It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to utilize the apparatus. Any of various conventional web browsers may be used to display and manipulate data on web pages. It is anticipated that the apparatus may be used to provide customer service by a customer service representative to a user within a metaverse.

Additionally, application program 119, which may be used by device 101, may include computer executable instructions for invoking user functionality related to communication, such as email, short message service (SMS), authentication services and voice input and speech recognition applications.

Device 101 and/or terminals 141 or 151 may also be referred to as nodes on a network and may be mobile terminals including various other components, such as a battery, speaker, and antennas (not shown). Terminal 151 and/or terminal 141 may be portable devices such as smart glasses, mobile phones, smart phones, tablet computers, computers, laptops, servers or any other suitable device for providing authentication services to a user.

Any information described above in connection with database 111, and any other suitable information, may be stored in memory 115. One or more of applications 119 may include one or more algorithms that encrypt information, process received executable instructions, interact with enterprise systems, perform power management routines or other suitable tasks. Algorithms may be used to perform various functions such as creating an avatar and providing customer service to a user, and/or performing any other suitable tasks.

In addition to regular computers, the invention may be operational with numerous other general purpose or special purpose computing system environments or configurations, particularly with respect to the server(s). Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, ATMs, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

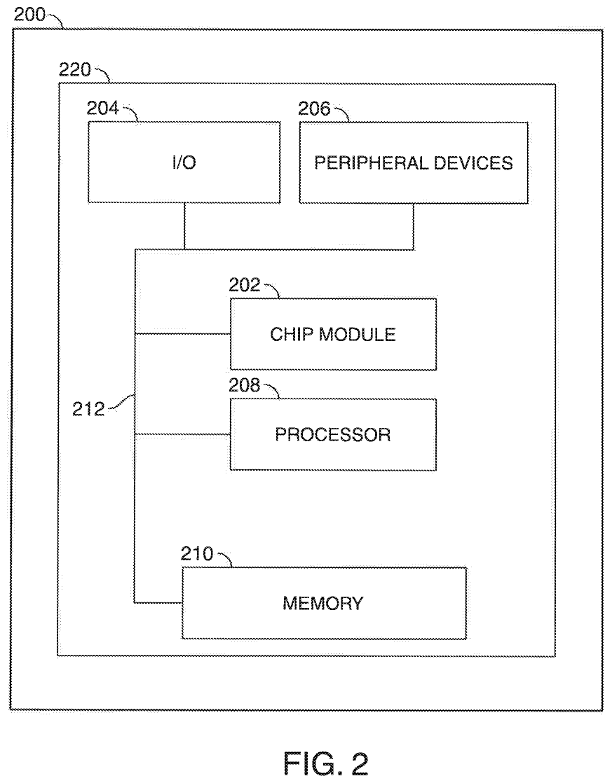

FIG. 2 shows an illustrative apparatus 200 that may be configured in accordance with the principles of the invention.

Apparatus 200 may be a computing machine, such as a server. Apparatus 200 may include one or more features of the apparatus that is shown in FIG. 1.

Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may run any software application or applications described herein, and machine-readable memory 210.

Machine-readable memory 210 may be configured to store in machine-readable data structures: data, programming functions, units of programming code associated with the programming functions and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

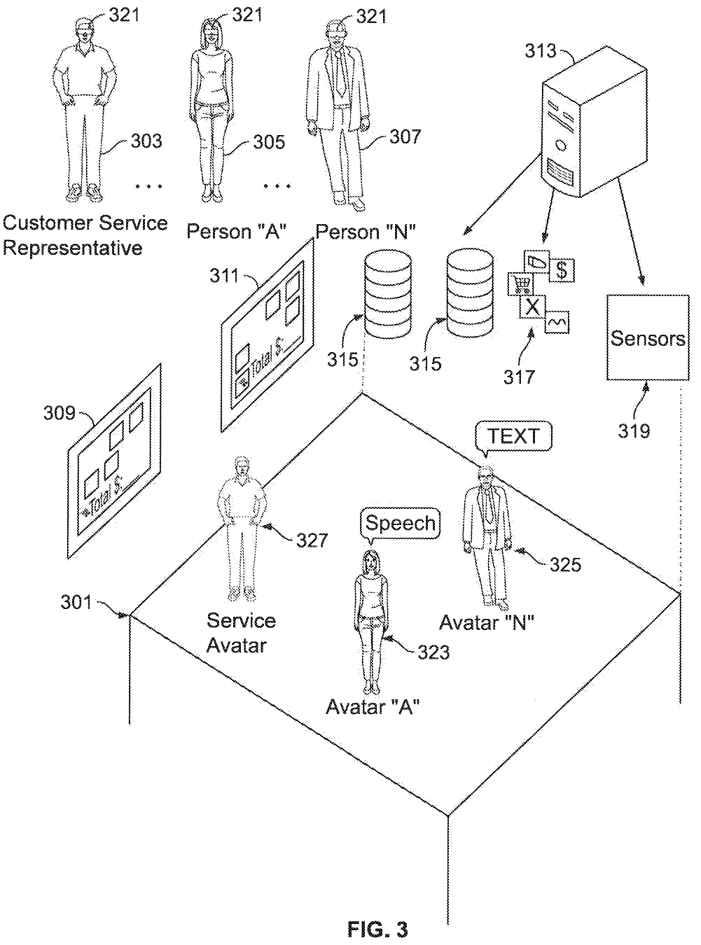

FIG. 3 shows an illustrative schematic of a metaverse in accordance with the principles of the disclosure.

Metaverse session 301 may be powered by one or more servers 313. Servers 313 may include databases 315, applications 317, and sensors 319, among other components.

Customer service representative 303, and users 305 and 307 (through “n” users) may access metaverse session 301 through virtual reality headsets 321 (one for each user). Other access capabilities may be used. Customer service representative 303, and users 305 and 307 may communicate with servers 313 to access metaverse session 301.

Customer service representative may appear as service avatar 327 within the metaverse session 301. Users 305 and 307 (through “n” users) may appear as avatars 325, 327 (through “n” avatars) within the metaverse session 301. The customer service representative 303 (through avatar 327) may interact with users 305 and 307 (through their avatars 323 and 325), and users 305 and 307 may interact with each other, with storefronts 309 and 311, other applications 317, or other aspects of metaverse session 301 (not shown).

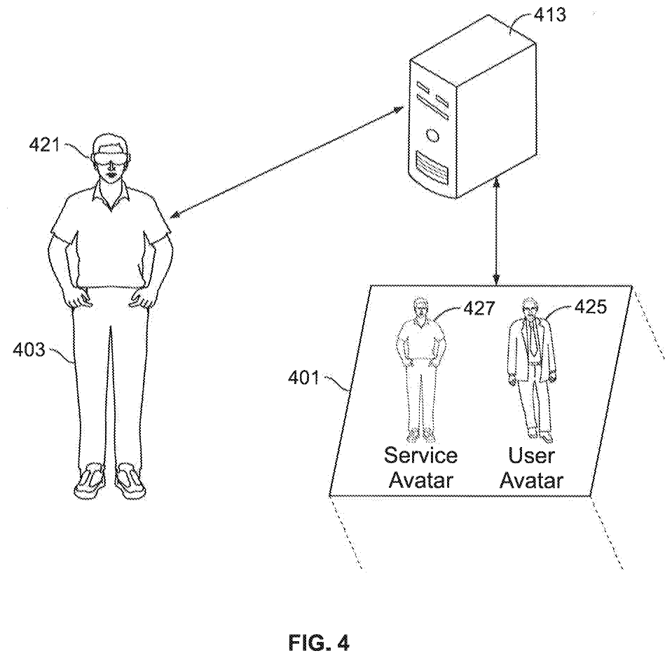

FIG. 4 shows an illustrative schematic in accordance with the principles of the disclosure.

User A (not shown) may be represented by avatar 425 in a metaverse session 401. Service representative 403 may be represented by service avatar 427 om metaverse session 401.

Service representative 403 may access metaverse session 401 through virtual reality glasses 421 or other apparatus. Service representative 403 may connect with server 413. Server 413 may function as an interface between service representative 403 and service avatar 427 within metaverse session 401. In an embodiment, once server 413 creates service avatar 427, service representative may interact with service avatar 427 directly and server 413 may not function as an interface between the two.

Server 413 may receive an assistance request from user avatar 425 or user A (not shown). Server 413 may create (or already have created) service avatar 427 (or, in an embodiment, a service avatar overlay). Server 413 may translate and transmit actions or instructions (i.e., assistance) from service representative 403 to service avatar 427 within metaverse session 401. In an embodiment, server 413 may translate assistance from one language to another, if the user and service representative 403 do not speak the same language.

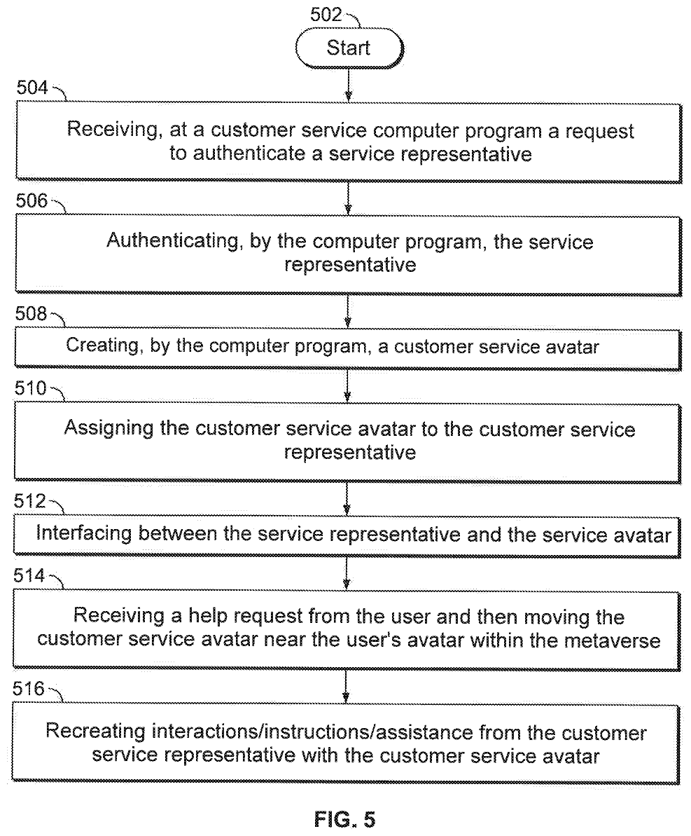

FIG. 5 shows an illustrative flowchart in accordance with principles of the invention. Methods may include some or all of the method steps numbered 502 through 516. Methods may include the steps illustrated in FIG. 5 in an order different from the illustrated order. The illustrative method shown in FIG. 5 may include one or more steps performed in other figures or described herein. Steps 502 through 516 may be performed on the apparatus shown in FIGS. 1-4 and 6, or other apparatus.

At step 502, the method may begin. At step 504, a customer service computer program product may receive a request to authenticate a customer service representative from the customer service representative. The service representative may transmit the request from any appropriate input channel, such as a desktop computer, mobile computer, mobile phone, smartphone application, or other channel. The input channel may be the same or different than an output channel. The input channel may have access to a metaverse session. The input channel may not have access directly to a metaverse session.

At step 506, the customer service computer program may authenticate the customer service representative. Any appropriate authentication method or protocol may be used. Standard authentication protocols such as passwords, PINs, measuring biometric attributes may be used alone or in combination. More secure and robust authentication methods may be used for more advanced (or higher tier) customer service representatives.

At step 508, the customer service computer program may create a customer service avatar (or avatar overlay) within the metaverse. In an embodiment, the service avatar (or avatar overlay) may automatically expire when an expiry condition has been met. An expiry condition may include: a particular time, an elapsed amount of time, another condition such as the exit of the service representative from the metaverse session or the completion of providing assistance to a user. Authentication or avatar creation may include a 3D scan of the service representative, or part of the service representative (such as the representative's face or head). A 3D scan may be used to create a computerized hologram or other avatar of the service representative or part of the service representative for use within the metaverse.

At step 510, the customer service computer program may assign the avatar to the customer service representative so that the service representative may use the avatar within a metaverse session.

At step 512, the customer service computer program may interface between the customer service representative and the customer service avatar by transmitting one or more interactions from the service representative to the service avatar. Any appropriate transmission or communication protocol may be used, including Wi-Fi, Bluetooth, cellular signals, etc. The customer service computer program may identify an appropriate output channel to interface with the service representative through one or more AI/ML algorithm(s). Appropriate output channels may include the input channel or other computing devices used by or belonging to the service representative. One appropriate output channel may be the computing device the service representative utilizes to access the metaverse session within which the service representative is providing assistance. This output channel may be the same or different than the input channel.

At step 514, the customer service computer program may receive a help request from a user and move the customer service avatar near the user/user's avatar within the metaverse.

At step 516, the customer service computer program may recreate the one or more interactions from the customer service representative with the customer service avatar so that the service representative's assistance may appear within the metaverse session. For example, the service representative may provide assistance to the user through text or speech, which may then be recreated (or translated) with the service avatar within the metaverse. Other interactions may be recreated as well, as appropriate to assist the user.

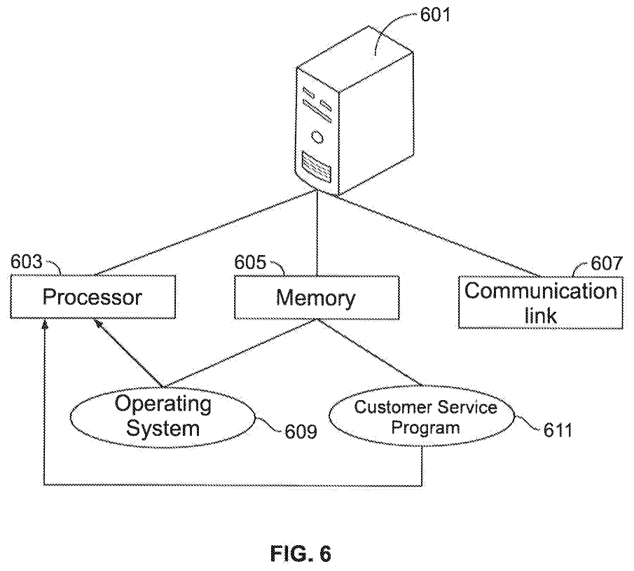

FIG. 6 shows an illustrative apparatus in accordance with the principles of the disclosure.

A server 601 may be centralized or distributed. The server 601 may include a processor 603, non-transitory memory 605, a communication link 607, as well as other components (not shown), such as an input/output module, a display, and peripherals.

The non-transitory memory 605 may include an operating system 609 and a customer service program 611, as well as other applications (not shown). The operating system 609 and authentication program 611 may include executable instructions that may be executed on the processor 603.

Among other things, the customer service program 611 may be configured to: receive, from a service representative, a request to authenticate the service representative; authenticate the service representative; create a service avatar within the metaverse; assign the service avatar to the service representative; and interface between the service representative and the service avatar by transmitting one or more interactions from the service representative to the service avatar. The service avatar may be configured to receive the one or more interactions from the service representative; move near the user avatar in response to a help request transmitted by the user; and recreates the one or more interactions within the metaverse.

Thus, apparatus and methods to supply customer service and assistance to a user within a metaverse have been provided. Persons skilled in the art will appreciate that the present disclosure can be practiced by other than the described embodiments, which are presented for purposes of illustration rather than of limitation. The present disclosure is limited only by the claims that follow.

What is claimed is:

1. A customer service computer program product for assisting a user within a metaverse, the computer program product comprising executable instructions, the executable instructions when executed by a processor on a computer system:
receive, from a service representative, a request to authenticate the service representative;
authenticate the service representative;
create a service avatar within the metaverse;
assign the service avatar to the service representative; and
interface between the service representative and the service avatar by transmitting one or more interactions from the service representative to the service avatar;
wherein the service avatar:
receives the one or more interactions from the service representative;
moves proximate to a user avatar in response to a help request transmitted by the user; and
recreates the one or more interactions within the metaverse.

2. The customer service computer program product of claim 1 wherein the transmission of the one or more interactions is encrypted.

3. The customer service computer program product of claim 1 wherein the service representative is an artificial intelligence (“AI”) bot.

4. The customer service computer program product of claim 1 wherein the service avatar comprises an avatar overlay.

5. The customer service computer program product of claim 1 wherein the service avatar is linked to a particular location within the metaverse.

6. The customer service computer program product of claim 5 wherein the particular location is an analogue of a geographical location.

7. The customer service computer program product of claim 1 wherein the service avatar automatically moves proximate to the user avatar within a pre-determined time of the help request.

8. The customer service computer program product of claim 1 wherein the service avatar moves proximate to the user avatar only when the user is authenticated.

9. The customer service computer program product of claim 1 wherein the service avatar moves proximate to the user avatar only when the user is authenticated to an appropriate level.

10. The customer service computer program product of claim 8 wherein:
the service representative is a tier-n service representative;
the service avatar is a tier-n service avatar; and
the user is authenticated to tier-n.

11. The customer service computer program product of claim 9 wherein:
the service representative is a tier-n service representative;
the service avatar is a tier-n service avatar; and
when the user is authenticated to tier-(n−1), a message is transmitted to the user declining movement of the tier-n service avatar.

12. A method for assisting a user within a metaverse, the method comprising:
receiving, at a customer service computer program, a request to authenticate a customer service representative;
authenticating, at the customer service computer program, the service representative;
creating, by the customer service computer program, a customer service avatar within the metaverse;
assigning the customer service avatar to the customer service representative;
interfacing between the customer service representative and the customer service avatar by transmitting one or more interactions from the service representative to the service avatar;
receiving a help request from the user;
moving the customer service avatar proximate to the user within the metaverse; and
recreating the one or more interactions from the customer service representative with the customer service avatar.

13. The method of claim 12 wherein the customer service computer program automatically moves the customer service avatar proximate to the user within the metaverse within a pre-determined time of receiving the help request from the user.

14. The method of claim 12 wherein the customer service avatar expires after a pre-determined length of time.

15. The method of claim 14 wherein the pre-determined length of time is variable.

16. The method of claim 12 wherein:
the customer service representative is a tier-n service representative;
the customer service avatar is a tier-n service avatar; and
the user is authenticated to tier-n.

17. The method of claim 16 wherein:
the service representative is a tier-n service representative;
the service avatar is a tier-n service avatar; and
when the user is authenticated to tier-(n−1), a message is transmitted to the user declining assistance to the user.

18. An apparatus for assisting a user within a metaverse, the apparatus comprising:
a server, the server comprising:
a communication link;
a processor; and
a non-transitory memory configured to store at least:
an operating system; and
a customer service program comprising executable instructions that when executed on the processor are configured to:
receive, from a service representative, a request to authenticate the service representative;
authenticate the service representative;
create a service avatar within the metaverse;
assign the service avatar to the service representative; and
interface between the service representative and the service avatar by transmitting one or more interactions from the service representative to the service avatar;
wherein the service avatar:
receives the one or more interactions from the service representative;
moves proximate to a user avatar in response to a help request transmitted by the user; and
recreates the one or more interactions within the metaverse.

19. The apparatus of claim 18 wherein the service avatar is available to assist the user when the user is authenticated to a particular standard.

20. The apparatus of claim 18 wherein the service avatar is prevented from assisting the user when the user is authenticated to a lower standard than the service avatar.
